(19) United States
(12) Patent Application Publication
(10) Pub. No.: US 2013/0239098 A1
(43) Pub. Date: Sep. 12, 2013

(54) SOURCE CODE CONVERSION METHOD AND SOURCE CODE CONVERSION PROGRAM

(71) Applicants: Makoto Ichii, Fujisawa (JP); Masaki Chikahisa, Fujisawa (JP); Hideto Noguchi, Sagamihara (JP); Takehiko Nagano, Yokohama (JP)

(72) Inventors: Makoto Ichii, Fujisawa (JP); Masaki Chikahisa, Fujisawa (JP); Hideto Noguchi, Sagamihara (JP); Takehiko Nagano, Yokohama (JP)

(21) Appl. No.: 13/814,744

(22) PCT Filed: Aug. 8, 2011
(86) PCT No.: PCT/JP2011/068089

§ 371 Date: May 14, 2013

(30) Foreign Application Priority Data
Sep. 9, 2010 (JP) 2010-201797

(51) Int. Cl. G06F 9/45

(52) U.S. Cl. CPC G06F 8/40
USPC 717/137

(57) ABSTRACT

In checking a model of software, there is an approach of transforming a source code of software into a checking code in order to reduce a cost required to describe the checking code by an input language of a model checker. Since a user may select only a single transformation method, there are problems in that an abstraction-level change is difficult, a rule modification cost for following up a design and a change of the source code is high, and a rule modification cost for checking using another checking tool is high. In the present invention, when the source code is transformed into the checking code, a unit that selects a plurality of transformation rules is provided to allow the user to easily change an abstraction level. Further, the plurality of transformation rules include a transformation rule of transforming the source code into an intermediate format, a transformation rule of abstracting the intermediate format, and a transformation rule of transforming the intermediate format into the checking code.

### TECHNICAL FIELD

The present invention relates to a source code transformation method and a source code transformation program, and particularly, to a method of transforming a source code of software into a checking code by using a calculator in order to reduce a cost required to describe the checking code with an input language of a model checker in model checking of software.

### BACKGROUND ART

In recent years, a software system penetrates a general society, and reliability required for software becomes very high, while software has become more complex and bigger, and thus it is very difficult to secure quality by review in manual work or a test.

A model checking technique as a method disclosed in, for example, Non-Patent Document 1, is a technique that describes a behavior of software with an input language of a specific model checker and executes the specific model checker to cyclopedically check a state which the software may take, which indicates whether a property which the software needs to have is satisfactory. According to the method disclosed in Non-Patent Document 1, checking is performed by describing a behavior of software with an input language called Promela and inputting the described behavior in a model checker called SPIN.

The model checking technique is a technique which is promising for securing quality of software which has become more complex and bigger, but cyclopedically checks the state which software may take, and thus a phenomenon called a state explosion in which the number of states to be checked is enormous occurs, and both or one of a phenomenon in which a time calculation amount required for processing becomes a realistically unallowable size and a phenomenon in which a space calculation amount required for processing is more than a storage region mounted on a calculator used in processing occurs in large-scale software, and as a result, the checking may not be completed.

In order to cope with the state explosion, processing called abstraction is performed with respect to a source code or a checking code, so that the number of states may be reduced to a checkable range. The abstraction includes simplification of a branching condition of, for example, a selection statement. Since an execution path which was not present originally may be generated or an execution path which is present may be extinct by the abstraction, a property of software which a checking result for a checking code expresses may be different from an original software property. Therefore, it is preferable to examine a level of the abstraction by considering a property to be checked with respect to software and then apply the abstraction.

Further, the model checking technique may have a practical problem in that an effort to describe software to be checked with an input language of a specific model checker is large. FIG. 11 illustrates one example of a source code transformation apparatus disclosed in Patent Document 1. According to a method disclosed in Patent Document 1, a source code is transformed into a checking code written with an input language of a specific model checker by using a translation map (steps 910 to 940). According to the method disclosed in Patent Document 1, the checking code is checked by the specific model checker by using an environment model defined by a user apart from the transformation (steps 975 and 950 to 970).

Further, as one of software engineering technologies, model-driven engineering is used. The model-driven engineering is a technology of performing software engineering by describing design information of software as a model and refining the model by a transforming operation. For example, in the model-driven engineering, a format or a meaning of a model is defined by a meta model described by an MOF which is a method disclosed in Non-Patent Document 2, a transformation rule of refining a model is described by a QUIT which is a method disclosed in Non-Patent Document 3, description and verification by a limitation associated with consistency or soundness by a model are performed by an OCL which is a method disclosed in Non-Patent Document 4, and a source code is generated from a model by a MOFM2T which is a method disclosed in Non-Patent Document 5.

In addition, a ‘model’ in the model checking technique and a ‘model’ in the model-driven engineering are concepts that are independent from each other and there is generally no commonality associated with a data structure or a meaning.

### PRIOR ART DOCUMENTS

### Patent Document

Patent Document 1: Japanese Patent Application Laid-Open Publication No. 2000-181750

### Non-Patent Document

Non-Patent Document 1: Gerard J. Holzmann, “The SPIN Model Checker Primer and Reference Manual”, Addison-Wesley Professional, 2003, ISBN: 978-0321228628
Non-Patent Document 2: The Object Management Group, “Meta Object Facility (MOF) Core Specification”, formal/06-01-01, January 2006, http://wwww.omg.org/spec/MOF/2.0/PDF
Non-Patent Document 3: The Object Management Group, “Meta Object Facility (MOF) 2.0 Query/View/Transformation Specification”, formal/2008-04-03, April 2008, http://www.omg.org/spec/QVT/1.0/PDF
Non-Patent Document 4: The Object Management Group, “Object Constraint Language”, formal/2006-05-01, May 2006, http://www.omg.org/spec/OCL/2.0/PDF
Non-Patent Document 5: The Object Management Group, “MOF Model to Text Transformation Language, v1.0”, formal/2008-01-16, January 2008, http://www.omg.org/spec/MOFM2T/1.0/PDF

### SUMMARY OF THE INVENTION

### Problems to be solved by the Invention

In order to effectively secure reliability of software by model checking, an effort for acquiring a checking code needs to be reduced by a method of automatically the checking code described by an input language of a model checker from a source code, and a specification and a design of software need to be abstracted so that cyclopedic checking by the model checker is terminated with a realistic time calculation amount and a realistic space calculation mount.

However, according to the method disclosed in Patent Document 1, there are problems in that (1) it is difficult to change an abstraction level, (2) a follow-up cost to software design change is high, and (3) a cost when checking is performed by another model checker is high.

Regarding the problem of (1), according to the method disclosed in Patent Document 1, a change of a translation map is limited only when a new type command is introduced into the source code, such as modification of a source program, and the like. Therefore, a method for a user to change the level of the abstraction is limited to a method of modifying a source code to be checked before transformation, a method of modifying a checking code written with an input language of a specific model checker after transformation, and a method of modifying an environment model, and the user makes a lot of efforts even in any method.

Regarding the problem of (2), according to the method disclosed in Patent Document 1, when a change such as a change of a, used library occurs, modification of the translation map and modification of the environment model need to be performed. However, when it is considered that the translation map is constituted by map components that directly transform the source code into the checking code and that the environment model is written with the input language of the specific model checker, modification is difficult while maintaining consistency to follow up the design and the change.

Regarding the problem of (3), according to the method disclosed in Patent Document 1, modification of the translation map and modification of the environment model need to be performed for checking with another model checker. However, when it is considered that the translation map is constituted by map components that directly transform the source code into the checking code and that the environment model is written with the input language of the specific model checker, both the translation map and the environment model need to be modified, and as a result, a large cost is required.

Further, there is a need that the user wants to manage a trade-off between a checking level and the number of states. That is, in checking a complex system, the state explosion easily occurs, and thus checking cannot be completed. In this case, it may be preferable that checking can be completed rather than a case where nothing can be checked even though a level is lowered a little. For example, when a specific error occurs only in repeated execution, the specific error is not detected by removing the repetition, but the number of states may be significantly reduced.

On the basis of the problems in the related art, an object of the present invention is to provide a source code transformation method and a source code transformation program that can flexibly cope with the level of the abstraction, and the like.

### Means of Solving the Problems

A representative composition of the present invention will be described below. A source code transformation method by a source code transformation apparatus includes: a step of inputting a source code of software; a step of inputting a plurality of different transformation rules; and a step of transforming the source code into a checking code described by an input language of a verification tool by the plurality of different transformation rules.

### Effects of the Invention

According to the present invention, there is provided an interface that inputs a plurality of transformation rules divided with a fine grade. Therefore, a change in abstraction level by a user is easily implemented by an operation of selecting and inputting a plurality of different transformation rules corresponding to a source code to be checked.

### BRIEF DESCRIPTION OF THE DRAWINGS

FIG. 1 is a diagram for describing a basic concept of the present invention.

FIG. 2 is a diagram for describing an input interface of a transformation rule in source code transformation processing of the present invention.

FIG. 3A is a diagram illustrating a configuration example of a source code transformation system according to a first embodiment of the present invention.

FIG. 3B is a diagram illustrating a configuration example of a source code transformation apparatus in the transformation system of FIG. 3A.

FIG. 4 is a diagram illustrating an example of a processing flow according to the first embodiment.

FIG. 5A is a diagram illustrating one example of an input operation in the source code transformation apparatus.

FIG. 5B is a diagram illustrating another example of an input operation in the source code transformation apparatus.

FIG. 6 is a diagram describing an operation of the source code transformation apparatus.

FIG. 7 is a diagram describing a source code transformation procedure in more detail.

FIG. 8A is a diagram illustrating one example of abstraction of a model.

FIG. 8B is a diagram illustrating one example of abstraction of a model.

FIG. 9 is a diagram illustrating an example of a processing flow of a source code transformation apparatus according to a second embodiment of the present invention.

FIG. 10 is a diagram describing a verification procedure of transformation consistency according to a third embodiment of the present invention.

FIG. 11 is a diagram illustrating one example of a source code transformation apparatus of a conventional example.

### MODE FOR CARRYING OUT THE INVENTION

In the present invention, a source code to be checked is transformed into a checking code described with an input language of a model checker by using a plurality of different transformation rules. In the plurality of different transformation rules, the source code to be checked is transformed into the checking code described with the input language of the model checker, a series of abstracted processing is divided with a fine grade, and the source code is transformed into the checking code by combining and using the plurality of transformation rules.

In the present invention, the series of processing of transforming the source code to be checked into the checking code is divided with the fine grade in addition to even the abstraction processing and the respectively divided processing is called a ‘transformation rule’. When a source code transformation apparatus implemented by the present invention transforms the source code into the checking code, the source code transformation apparatus has an interface for the user to select and input the plurality of different transformation rules. The transformation rule is input by one unit of selection from the plurality of transformation rules accumulated in the source code transformation apparatus in advance and user description.

Further, in the present invention, the plurality of the transformation rules are classified into an installation-generalization transformation rule of transforming a source code into a type (generalization model) having generalized program information which does not depend on a descriptive language of the source code, an abstraction transformation rule of abstracting the generalization model, and a generalization-checking transformation rule of transforming the generalization model into a descriptive language of a model checker. In other words, the plurality of different transformation rules are classified into a first transformation rule of transforming a source code into an intermediate format which is a format not dependent on a specific programming language, a second transformation rule of performing abstraction processing of the intermediate format, and a third transformation rule of transforming the intermediate format into the checking code. Transformation of a source code into a checking code is implemented by subsequently performing three steps of a step of transforming a source code into a generalization model by the installation-generalization transformation rule, a step of abstracting the generalization model by the abstraction transformation rule, and a step of transforming the generalization model into a checking code by the generalization-checking transformation rule. In other words, transformation of the source code into the checking code is implemented by a step of inputting each of one or more first, second, and third transformation rules, and subsequently performing three steps of a step of transforming a source code of software into the intermediate format by using the first transformation rule, a step of abstracting software expressed in the intermediate format by using the second transformation rule, and a step of transforming the intermediate format into a verifying code described by an input language of a verification tool by using the third transformation rule.

Further, in the present invention, in a series of processing of transforming a source code to be checked into a checking code, a format of information (model) which is internally kept is defined by a plurality of meta models. The plurality of models are classified into an installation model having information corresponding to a source code to be checked, the aforementioned generalization model, and a checking model having information corresponding to the descriptive language of a model checker. The installation model is defined by a meta installation model which is a meta model thereof, the generalization model is defined by a meta generalization model which is a meta model thereof, and the checking model is defined by a meta checking model which is a meta model thereof. The respective meta models store a definition of a data structure and information on a limitation between components included in data.

Hereinafter, embodiments of the present invention will be described in detail with reference to the accompanying drawings.

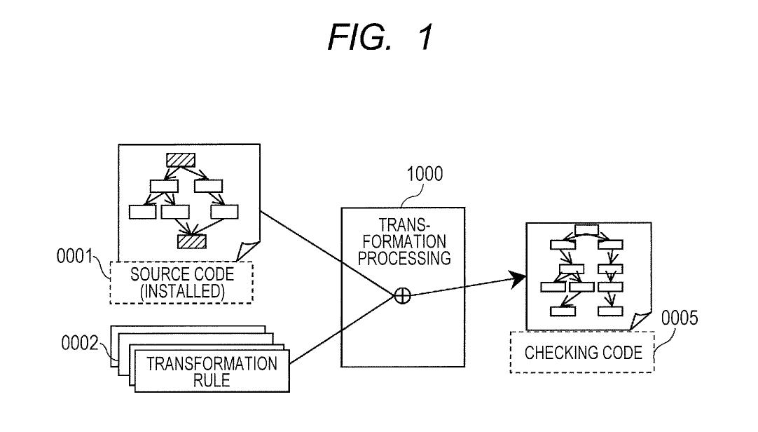

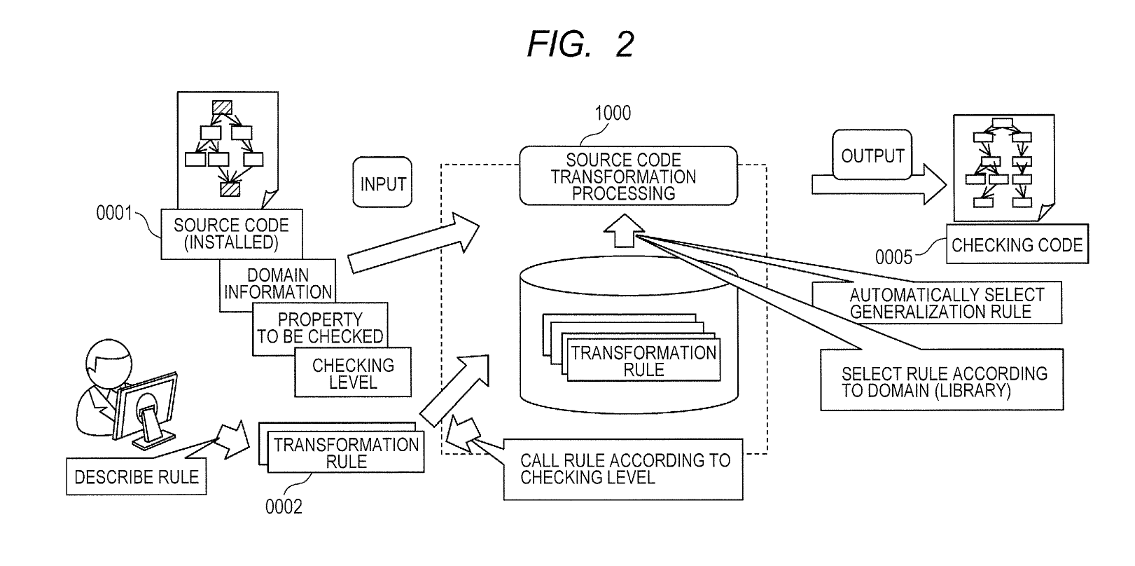

First, a basic concept of the present invention will be described with reference FIGS. 1 and 2. In the present invention, as illustrated in FIG. 1, transformation processing in which a plurality of transformation rules 0002 is combined is performed with respect to a source code 0001 in a source code transformation processing apparatus 1000 to transform the source code 0001 into a checking code 0005 suitable for an existing model checking apparatus. That is, (a) “transformation” is divided with a fine grade and is packaged by the combination of the plurality of ‘transformation rules’ 0002 to implement flexible transformation. (b) A user (checker) inputs the source code 0001 to be checked and selects the ‘transformation rule’ 0002 according to a target source code and a checking level to acquire a desired checking code 0005.

In the present invention, an example of the ‘transformation rules’ are as follows.

(a) Simple syntax transformation

‘Conditional branching (If statement•Switch statement) of C language’ is transformed into ‘conditional branching (If statement) of checking code’

‘Repetition statement (for statement•while statement• . . . ) of C language’ is transformed into ‘repetition (Do statement) of checking code’

(b) Modeling of external environment

‘Data reading’ is substituted by ‘random input’

(c) Abstraction

‘Removal of repetition’

‘Simplification of condition’

An input interface of the transformation rules in source code transformation processing of the present invention will be described with reference to FIG. 2.

According to the present invention, by providing an interface that inputs the plurality of transformation rules 0002 divided with the fine grade, the abstraction-level change by the user is easily implemented by an operation of selecting and inputting the plurality of different transformation rules 0002. That is, the abstraction-level change by the user is easily implemented by an operation in which the user selects and calls the plurality of different transformation rules 0002 to input the selected and called rule in the source code transformation processing apparatus 1000, according to domain information, a property to be checked, and checking-level information (abstraction influences abstraction). Therefore, a problem in which the abstraction-level change is difficult is solved.

The present invention includes a procedure of transforming the source code 0001 to be checked into the checking code 0005 described by the input language of the model checker by using the plurality of different transformation rules 0002. A procedure is included, in which the plurality of different transformation rules are classified into the installation-generalization transformation rule, the abstraction transformation rule, and the generalization-checking transformation rule, and as a result, transformation is performed stepwise. At the time of following up the design change of the source code to be checked, only a transformation rule associated with the change needs to be changed, and thus the change may be just minimal. Moreover, the installation model, the generalization model, and the checking model are defined by the meta models, respectively and a limit is put, and as a result, it may be verified that a transformation result by the transformation rule is not false. Therefore, a series of processing of abstracting and transforming a source code to be checked into a checking code is implemented by combining the transformation rules with the fine grade, and as a result, an increase of a verification cost of the transformation rule may be prevented.

Further, for checking using another checking tool, only the meta-checking model and the generalization-checking transformation rule need to be prepared in output in a format of the checking tool, and as a result, a preparation part may be just minimal. Therefore, a problem in which a cost in checking using another model checker is high is solved.

### First Embodiment

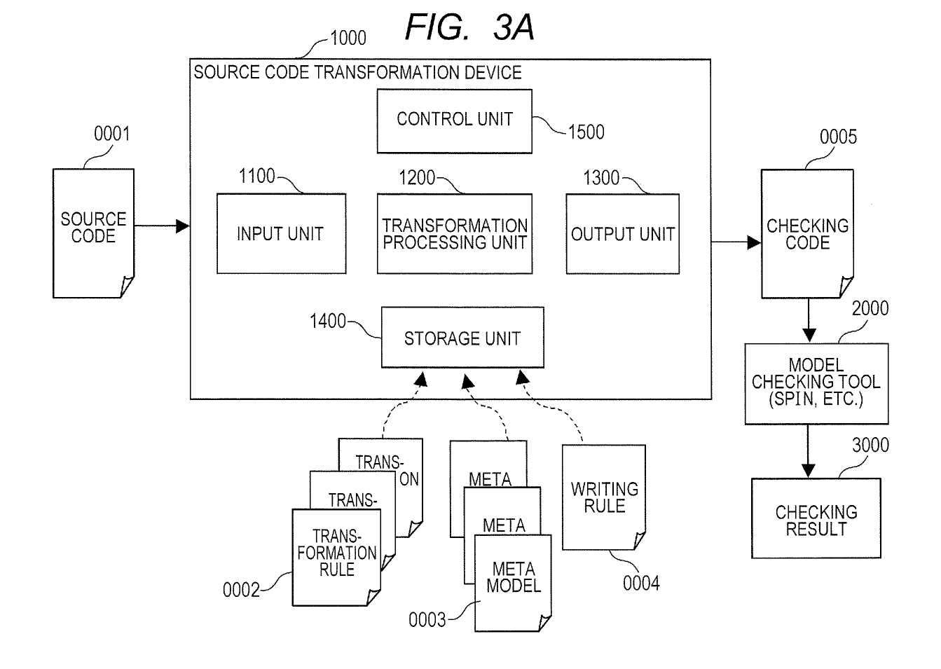

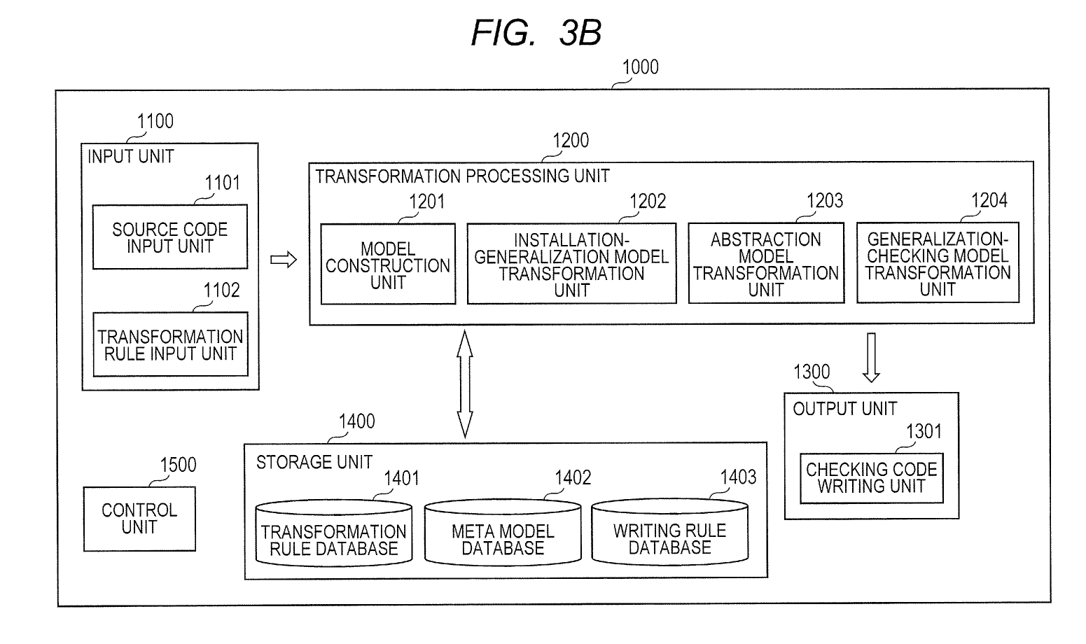

Next, a source code transformation apparatus and a source code transformation processing method according to a first embodiment of the present invention will be described with reference to FIGS. 3A to 8.

FIG. 3A is a diagram illustrating a configuration example of a source code transformation system including the source code transformation apparatus according to the first embodiment of the present invention. The source code transformation apparatus 1000 applied to the embodiment of the present invention is an apparatus that transforms the source code 0001 to be checked into the checking code 0005, which includes an input unit 1100, a transformation processing unit 1200, an output unit 1300, a storage unit 1400, and a control unit 1500. Reference numeral 2000 represents a model checking tool and reference numeral 3000 represents a checking result.

FIG. 3B illustrates a configuration example of the source code transformation apparatus 1000. The input unit 1100 includes a source code input unit 1101 and a transformation rule input unit 1102. The transformation processing unit 1200 includes a model construction unit 1201, an installation-generalization model transformation unit 1202, an abstraction model transformation unit 1203, and a generalization-checking model transformation unit 1204. The output unit 1300 includes a checking code writing unit 1301. The storage unit 1400 includes a transformation rule database 1401, a meta model database 1402, and a writing rule database 1403. The control unit 1500 controls overall processing of the source code transformation apparatus 1000.

The source code transformation apparatus 1000 is implemented as a program that operates on, for example, one computer or a plurality of computers connected through a network. The source code 0001 and the transformation rule set 0002 are input by methods such as, for example, a method of reading from a storage device on the computer and a method of direct input by an input device connected to the computer. Further, the checking code 0005 is output by, for example, a method of writing in the storage device on the computer and a method of displaying on a display device of the computer.

The input unit 1100 performs processing of receiving data input by a user and providing the input data to the transformation processing unit 1200. The input unit 1100 receives information regarding the source code 0001 and information regarding the plurality of transformation rules divided with the fine grade, that is, the ‘transformation rule set’ 0002 and provides the corresponding information to the transformation processing unit 1200. In some embodiments, the input unit 1100 may receive a command associated with driving or controlling of the transformation processing unit and driving or controlling of the output unit, from the user.

The transformation processing unit 1200 receives the information of the source code 0001, the information of the transformation rule set 0002 to be applied to the source code 0001 from the input unit to perform the processing of transforming the source code 0001 by the transformation rule set 0002 and provides information on a transformation result to the output unit 1300. In some embodiments, information regarding the transformation rule set 0002 provided from the input unit includes only identification information indicating the transformation rule stored in the storage unit, and as a result, an entity of the transformation rule set 0002 is taken out from the storage unit 1400 by using the identification information to be used in transformation.

The transformation processing unit 1200 includes the model construction unit 1201, the installation-generalization model transformation unit 1202, the abstraction model transformation unit 1203, and the generalization-checking model transformation unit 1204. In the embodiment, the transformation processing unit 1200 transforms source code information 1001 into a checking model 1008 by model transformation using the meta models and the transformation rules. A meta installation model 1002, a meta generalization model 1003, and a meta checking model 1004 are described by, for example, an MOF disclosed in Non-Patent Document 2. Further, for example, model transformation is performed by describing an installation-generalization transformation rule 1005, an abstraction transformation rule 1006, and a generalization-checking transformation rule 1007 by a QVT disclosed in Non-Patent Document 3. The transformation may be another model transformation method of an already exemplified method and further, in the transformation, a plurality of methods may coexist.

Further, in some embodiments, the installation-generalization model transformation unit 1202, the abstraction model transformation unit 1203, and the generalization-checking model transformation unit 1204 are not independent from each other but may be constituted by the same part and further, as meta models of the installation model 1205, the generalization model 1206, and the checking model 1008, the meta installation model 1002, the meta generalization model 1003, and the meta checking model 1004 are not individually prepared and the installation model 1205, the generalization model 1206, and the checking model 1008 may be defined by a single meta model. In addition, in some embodiments, the meta installation model 1002, the meta generalization model 1003, and the meta checking model 1004 may define formats and limits of the installation model 1205, the generalization model 1206, and the checking model 1008, respectively by a plurality of methods. For example, the respective meta models include a limit condition described by an OCL disclosed in Non-Patent Document 4 in addition to a definition by the MOF and when model transformation is performed, a method of verifying whether the limit condition is satisfied may be provided.

The model construction unit 1201 receives the source code information 1001 from the source code input unit 1101 and transforms the received source code information into the installation model 1205. The format of the installation model 1205 is defined by the meta installation model 1002 which is the meta model thereof. The installation model 1205 preferably has sufficient information required to be transformed with the source code information 1001 in order to maximally acquire the effect of the present invention but in some embodiments, information may be omitted or added without deviating from a purpose of outputting the checking code.

In some embodiments, the model construction unit 1201 is installed in an aspect which the model construction unit 1201 is inseparable from the source code input unit 1101, and as a result, processing may be performed in such a manner that the source code information 1001 is not generated.

The installation-generalization model transformation unit 1202 transforms the installation model 1205 into the generalization model 1206 by using the installation-generalization transformation rule 1005, the meta installation model 1002, and the meta generalization model 1003. The generalization model has a data structure which may express a structure or processing in a plurality of programming languages. For example, in the generalization model, an If statement and a Switch statement are not distinguished from each other in the source code 0001 and the generalization model is expressed as a selection statement. In some embodiments, when the installation model 1205 is transformed into the generalization model 1206, only the installation-generalization transformation rule 1005 may be used. Further, in some embodiments, when the installation-generalization transformation rule 1005 includes the plurality of transformation rules, a method may be provided, in which the plurality of transformation rules are integrated into one transformation rule to be used in the transformation of the installation model 1205 into the generalization model 1206. Further, in some embodiments, when the installation-generalization transformation rule 1005 includes the plurality of transformation rules, a procedure of transforming the installation model 1205 into the generalization model 1206 may be provided by repeating transformation processing several times.

The abstraction model transformation unit 1203 performs abstraction of the generalization model 1206 by using the abstraction transformation rule 1006 and the meta generalization model 1003. As an example of the abstraction, a method may be provided, in which a conditional equation in the selection statement is substituted to always valid or always false, or non-deterministic selection. In some embodiments, when the generalization model 1206 is abstracted, only the abstraction transformation rule 1006 may be used. Further, in some embodiments, when the abstraction transformation rule 1006 includes the plurality of transformation rules, a method may be provided, in which the plurality of transformation rules are integrated into one transformation rule to be used in the abstraction of the generalization model 1206. Further, in some embodiments, when the abstraction transformation rule 1006 includes the plurality of transformation rules, a procedure of transforming the generalization model 1206 may be provided by repeating transformation processing several times.

The generalization-checking model transformation unit 1204 transforms the generalization model 1206 into the checking model 1008 by using the generalization-checking transformation rule 1007, the meta generalization model 1003, and the meta checking model 1004. For example, when the checking code 0005 is a Promela type, a component expressed as the selection statement in the generalization model is expressed as the If statement in the checking model. In some embodiments, when the generalization model 1206 is transformed into the checking model 1008, only the generalization-checking transformation rule 1007 may be used. Further, in some embodiments, when the generalization-checking transformation rule 1007 includes the plurality of transformation rules, a method may be provided, in which the plurality of transformation rules are integrated into one transformation rule to be used in the transformation of the generalization model 1206 into the checking model 1008. Further, in some embodiments, when the generalization-checking transformation rule 1007 includes the plurality of transformation rules, a procedure of transforming the generalization model 1206 into the checking model 1008 may be provided by repeating transformation processing several times.

The output unit 1300 outputs the checking code 0005 by using information on the transformation result provided from the transformation processing unit 1200. In some embodiments, at the time of outputting the checking code 0005, information such as, for example, grammar information of the descriptive language of the model checker, and the like may be provided from the storage unit.

The checking code writing unit 1301 transforms the checking model 1008 into the checking code 0005 by using the meta checking model 1004, and the checking code writing rule 1009 acquired from the writing rule database 1403 of the storage unit 1400. For example, by the method disclosed in Non-Patent Document 5, the checking code writing rule 1009 is described to transform the checking model 1008 into the checking code 0005. Some embodiments are not limited thereto and an arbitrary method of transforming the checking model 1008 into a descriptive format of the model checker used in checking may be used. The checking code 0005 is described by Promela which is an input language of a SPIN when the SPIN is used as, for example, the model checker.

In the storage unit 1400, the transformation rule database 1401, the meta model database 1402, and the writing rule database 1403 each are implemented by an arbitrary data storing method implemented on a computer such as, for example, a relationship database or a hierarchical database. The transformation rule database 1401, the meta model database 1402, and the writing rule database 1403 need not be implemented in the same method and may be implemented by different methods. Further, the checking rule database 1401, the meta model database 1402, and the writing rule database 1403 each need not be implemented in a single method and may be implemented, for example, by combining different methods such as storing some of information to be stored in the relationship database and including some of the information to be stored in a computer program implementing an invention.

The storage unit 1400 provides information required for the input unit 1100, the transformation processing unit 1200, and the output unit 1300 to perform the respective processing. For example, the storage unit 1400 stores information on the transformation rule, information on the meta model, and information on a grammar of the descriptive language of the model checker.

The transformation rule database 1401 stores the transformation rule together with the meta data as described above. The meta data is used to select the transformation rule and methods having different information of the installation-generalization transformation rule 1005, the abstraction transformation rule 1006, and the generalization-checking transformation rule 1007 may be provided. The meta data of the installation-generalization transformation rule 1005 may include, for example, a type of a descriptive language of a source code of a transformation source. The meta data of the abstraction transformation rule 1006 may include, for example, a name expressed plainly to easily know the abstraction, a simple description, types of the abstraction such as ‘abstraction of data’, ‘abstraction of processing’, and the like, an effect of reduction in the number of states by abstraction expressed by a natural word, alphabet, or a numerical value, an influence of the abstraction expressed by the natural word, the alphabet, or the numeral value on the property, and a domain of software to which the abstraction may be applied. The meta data of the generalization-checking transformation rule 1007 may include, for example, a name indicating the model checker used in checking.

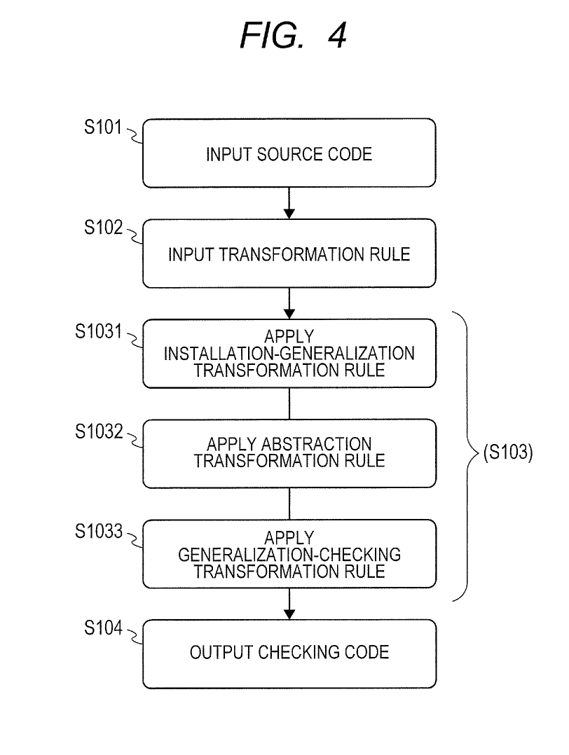

Thereafter, referring to FIGS. 4 to 6, the input unit 1100, the transformation processing unit 1200, the output unit 1300, the storage unit 1400, and the control unit 1500 will be described in detail.

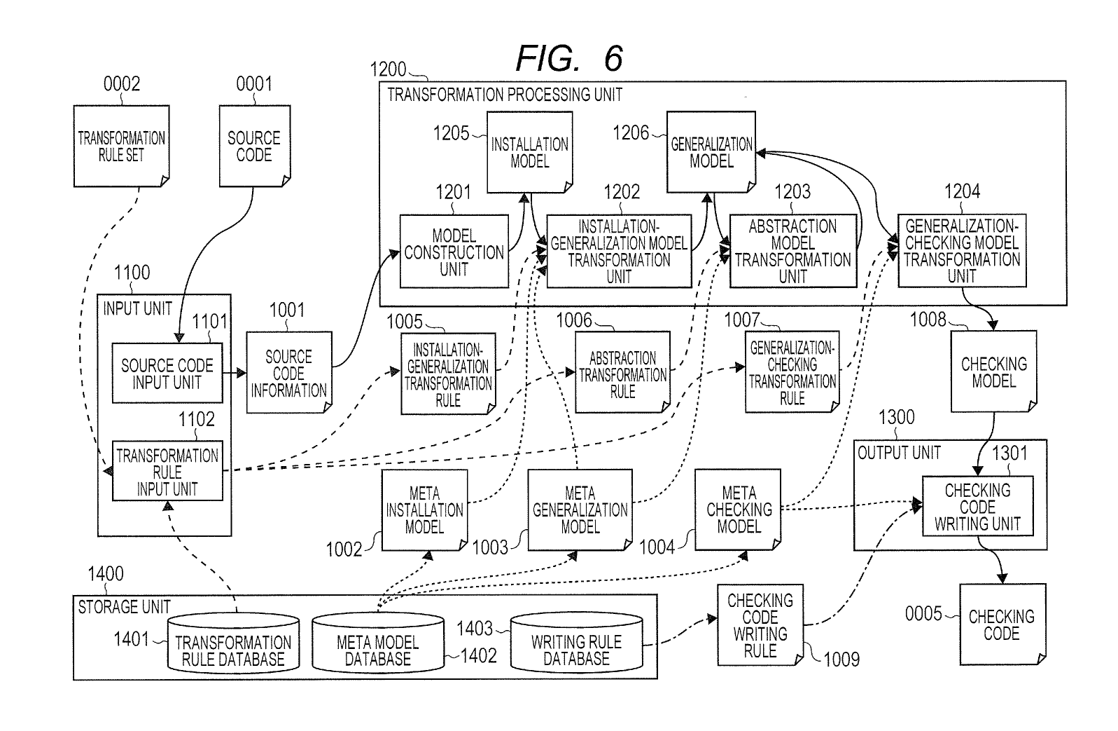

First, one example of a source code transformation procedure in the embodiment will be described with reference to FIGS. 4 and 6. The source code transformation procedure in the embodiment includes a source code inputting step S101, a transformation rule inputting step S102, a transformation rule applying step S103, and a checking code outputting step S104. The control unit 1500 becomes a main agent to perform the source code transformation procedure.

First, in the source code inputting step S101, the source code 0001 is read in the source code transformation apparatus 1000 to be transformed into the source code information 1001 by the source code input unit 1101.

The source code input unit 1101 receives the source code 0001 to be checked which is input from the user and transforms the received source code 0001 into the source code information 1001. The source code 0001 is described by a programming language C opened in, for example, JIS X3010-1993. The source code information 1001 is maintained particularly in, for example, a format of an abstract syntax tree. The format of the source code information 1001 is not limited to the abstract syntax tree and may be an arbitrary format in which information required for checking the source code 0001, such as a structure or logic is stored.

Subsequently to the source code inputting step S101, the transformation rule set 0002 which are the plurality of transformation rules divided with the fine grade are read in the source code transformation apparatus 1000 by the transformation rule input unit 1102, in the transformation rule inputting step S102. In the transformation rule inputting step S102, any one side or both sides of a corresponding relationship between a component of a model before transformation and a component of a model after transformation, and an operation applied to the component of the model before transformation by transformation are defined. Processing in which the transformation rule set 0002 are read in the source code transformation apparatus 1000 need not be performed by one operation by the user and may be performed by a repeated operations. Further, the source code inputting step S101 and the transformation rule inputting step S102 need not be particularly completed in this order, and the source code 0001 may be input before the source code information 1001 is generated by the source code input unit 1101, and further, the source code 0001 may be input before the transformation rule input unit 1102 requests the source code information 1001 for inputting the transformation rule, and thus processing may be performed in an order in which the processing of the source code inputting step S101 and the processing of the transformation rule inputting step S102 coexist. For example, a procedure may be present, in which the source code input unit 1102 receives the source code 0001, the transformation rule input unit receives the transformation rule set 0002, and then the source code input unit 1102 transforms the source code 0001 into the source code information 1001.

The transformation rule input unit 1102 receives the transformation rule set 0002 input from the user. A method of receiving the transformation rule set 0002 from the user may include, for example, the following methods.

As a first example of the transformation rule inputting method, the transformation rule input unit 1102 takes a transformation rule which the user directly inputs manually, as some of the transformation rule set 0002.

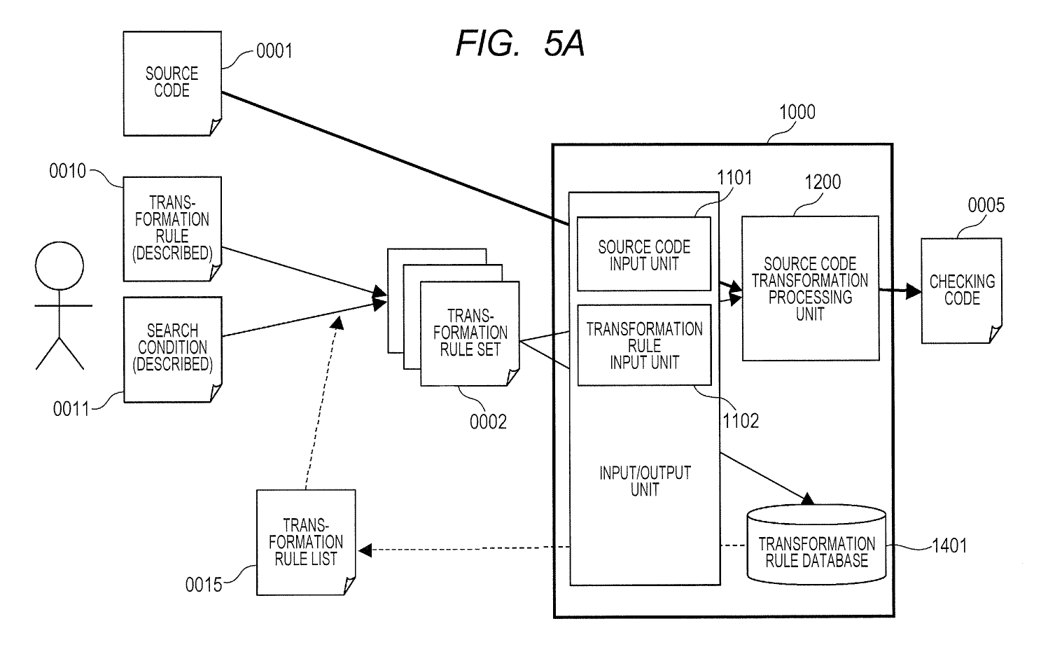

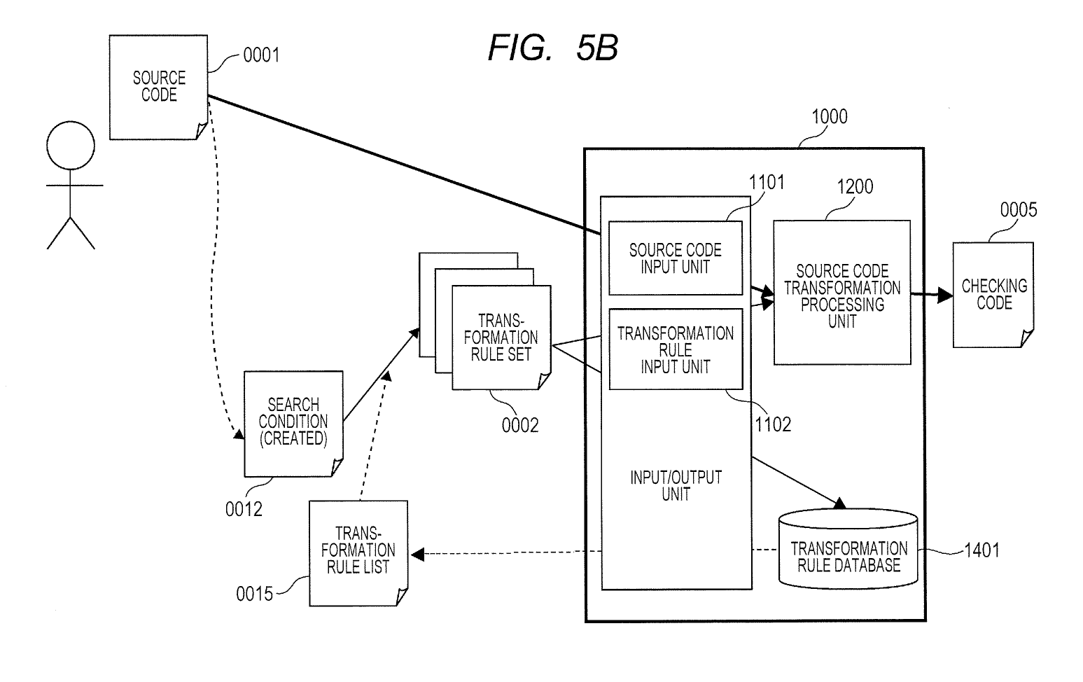

As a second example of the transformation rule inputting method, at least some of the transformation rule set 0002 may be input by a transformation rule (description) 0010 which the user describes, as illustrated in FIG. 5A. Alternatively, when the input unit 1100 acquires a transformation rule list 0015 from the storage unit 1400 and presents the acquired list to the user in a format of the list and the user selects the transformation rule from the list, the input unit 1100 may receive an input of the transformation rule set 0002. That is, the user inputs (describes) inputs a retrieval condition 0011 of the transformation rule in the transformation rule input unit 1102 of the input unit 1100 before inputting the transformation rule, and then the transformation rule input unit 1102 acquires a transformation rule, which coincides with the retrieval condition, from the transformation rule database 1401 of the storage unit 1400 and thus presents the acquired the transformation rule to the user as the transformation rule list 0015. Subsequently, the user selects one or more transformation rules included in the presented transformation rule list. The transformation rule input unit 1102 receives one or more transformation rules selected by the user as some of the transformation rule set 0002.

As a third example of the transformation rule inputting method, first, the user may input the retrieval condition 0011 of the transformation rule into the transformation rule input unit 1102 before inputting the transformation rule, and subsequently, the transformation rule input unit 1102 may acquire the transformation rule which coincides with the retrieval condition from the transformation rule database 1401 and receive the acquired transformation rule as some of the transformation rule set 0002.

As a fourth example of the transformation rule inputting method, the transformation rule input unit 1102 extracts and generates a retrieval condition 0012 of the transformation rule from the input source code 0001 and acquires the transformation rule which coincides with the retrieval condition from the transformation rule database 1401 and thus receives the acquired transformation rule as some of the transformation rule set 0002, as illustrated in FIG. 5B.

In the second example of the transformation rule inputting method, the third example of the transformation rule inputting method, and the fourth example of the transformation rule inputting method, a factor of the retrieval condition of the transformation rule may include, for example, information stored in the transformation rule database 1401 as meta data of the transformation rule, which is described below.

Further, as a fifth example of the transformation rule inputting method, the transformation rule input unit 1102 receives the transformation rule by processing a transformation rule input by some method. An example of the processing method may include a method in which the transformation rule is kept in the transformation rule database 1401 in a state in which a variable name, and the like in the source code 0001 is parameterized and filling the parameter with information of the source code 0001 is included in the transformation rule set 0002 by, for example, a method by a user's explicit input. In the fifth example of the transformation rule inputting method, an example of a method of inputting a transformation rule of a processing source may include the same method as a case where the input transformation rule is not processed but used, such as the first example of the transformation rule inputting method, and the like.

A method for the transformation rule input unit 1102 to receive the transformation rule set 0002 is not limited to these transformation rule inputting methods but may be an arbitrary method of receiving the transformation rule set used by the transformation processing unit 1200 and may receive the transformation rule set 0002 by one or more combinations of the transformation rule inputting methods.

Subsequently to the transformation rule inputting step S102, in the transformation rule applying step S103, the model construction unit 1201 transforms the source code information 1001 into the installation model 1205, the installation-generalization model transformation unit 1202 transforms the installation model 1205 into the generalization model 1206 (S1031), the abstraction model transformation unit 1203 abstracts the generalization model 1206 (S1032), and then the generalization-checking model transformation unit 1204 transforms the generalization model 1206 into the checking model 1008 (S1033). The transformation rule inputting step S102 and the transformation rule applying step S103 need not be particularly completed in this order, the installation-generalization transformation rule 1005 may be input up to the processing of the installation-generalization model transformation unit 1202, the abstraction transformation rule 1006 may be input up to the processing of the abstraction model transformation unit 1203, and the generalization-checking transformation rule 1007 may be input up to the processing of the generalization-checking model transformation unit.

Subsequently to the transformation rule applying step S103, in the checking code outputting step S104, the checking model 1008 is written as the checking code 0005 by the checking code writing unit 1301. A writing destination of the checking code 0005 need not be particularly be designated after the transformation rule applying step S103 and may be designated before writing the checking code 0005. For example, there may be a procedure in which the writing destination of the checking code 0005 is designated in parallel to the source code inputting step S101.

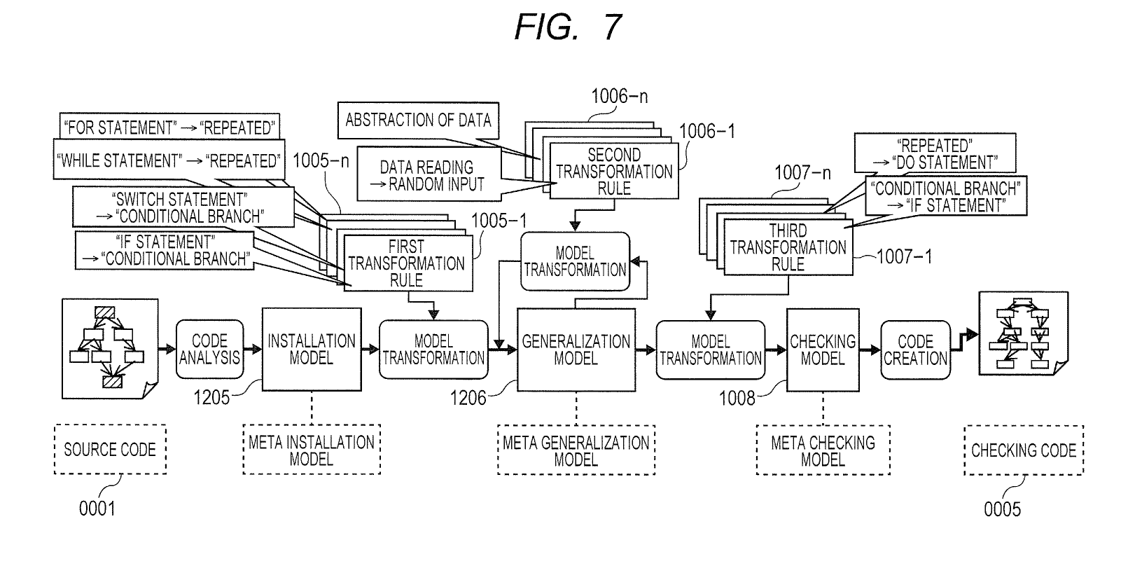

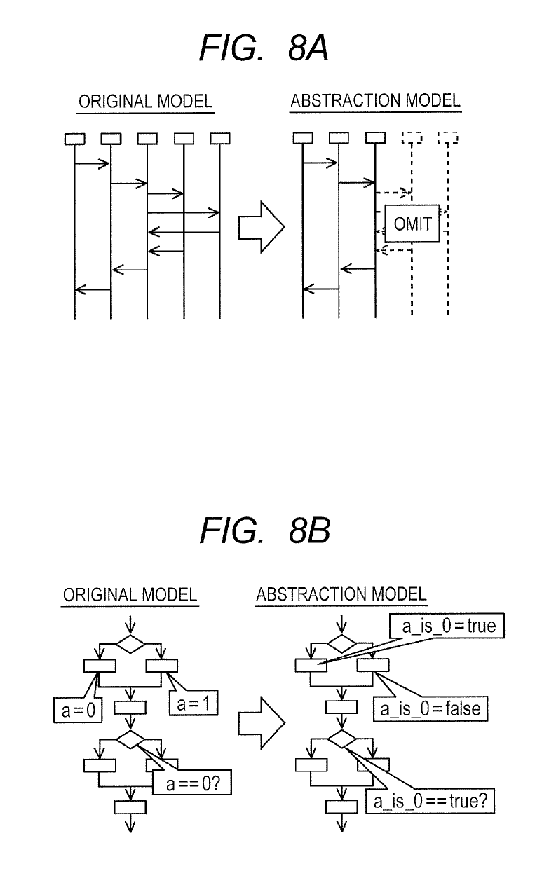

Next, a transformation procedure will be described in more detail by using FIGS. 7, 8A, and 8B. As illustrated in FIG. 7, the following processing is performed by using a model transformation technology for stepwise transformation in the present invention.

(1) The source code 0001 is transformed into the ‘installation model’ 1205 (substantially) equivalent thereto

(2) The ‘installation model’ is transformed into the ‘generalization mode’ expressing program information such as a structure or logic in a format which is not dependent on a specific programming language

That is, the ‘installation model’ 1205 is transformed into the ‘generalization model’ 1206 of an intermediate format which is a format not dependent on the specific programming language by using at least one of a plurality of different first transformation rules 1005-1 to 1005-n. In an example of FIG. 7, as the first transformation rule, at least four different transformation rules of ‘if statement→conditional branching’, ‘switch statement→conditional branching’, ‘while statement→repeated’, and ‘for statement→repeated’ are selected.

(3) The generalization model 1206 is transformed for abstraction

That is, the generalization model of the intermediate format is abstracted by using at least one of a plurality of different second transformation rules 1006-1 to 1006-n. In the example of FIG. 7, as the second transformation rules, at least two different transformation rules of ‘data reading→random input’ and ‘abstraction of data’ are selected.

(4) The generalization model is transformed into the ‘checking model’ to generate (output) a code That is, the generalization model 1206 of the intermediate format is transformed into the checking model 1008 having information required to generate the checking code by using at least one of a plurality of different third transformation rules 1007-1 to 1007-n. In the example of FIG. 7, as the third transformation rule, at least two different transformation rules of ‘conditional branching→if statement’, ‘repeated do statement’ corresponding to the first transformation rule are selected.

Further, a data structure and a semantic theory of each of the installation model, the generalization model, and the checking model are defined by the ‘meta model’ that defines syntax.

Like this, when the installation model is transformed into the generalization model, for example, in the case where a grammar of a descriptive language of a source code to be transformed includes “for statement” or “while statement” as a technique of repetition processing, the user selects a rule of transforming “for statement” into ‘repeated’ and a rule of transforming “while statement” into ‘repeated’ as the first transformation rule by using the aforementioned transformation rule inputting method. When the abstraction of the generalization model is transformed, as a transformation rule in which the user determines the checking level (abstraction degree) and achieves the determined checking level, for example, a rule of transforming a command and a series of processing regarding external data reading into a random input and a rule of transforming a specific data format into a format having a higher abstraction degree are selected as the second transformation rule by using the aforementioned transformation rule inputting method. Further, in transforming the generalization model into the checking model, for example, when grammar of an input language of a model checker has “do statement” as a technique of repetition processing, a rule in which the user transforms ‘repeated’ into “do statement” is selected as the third transformation rule by using the aforementioned transformation rule inputting method. As the transformation rule, generalized rules applicable throughout a plurality of software which are repeatedly usable are made to a database. The transformation rule stored in the database has domain information or information of the checking level (an influence of the abstraction on the checking) as meta information used as a material for determining retrieval or rule selection by the user.

Further, the selection method of the transformation rules will be described below.

(1) Generalized rule: always selected

(2) Rule which depends on a specific library: organized and selected by inputting a used library or a domain (category) to be checked

(3) Rule corresponding to abstraction: automatically generated from a property selected by the user or which the user himself/herself wants to input or check through description, from the transformation rule list (acquired by inputting the desired checking property and checking level)

FIGS. 8A and 8B illustrate examples of the abstraction of the model, respectively. The number of states may be reduced by the abstraction of the model. However, the abstraction may influence the property of the model. For example, a detected defect (counter example) is not present in an original system or the defect that is present in the original system may not be discovered. Meanwhile, sound abstraction that does not influence the property tends to be small in an effect of reduction in number of states.

According to the embodiment, an interface of inputting the plurality of transformation rules divided with the fine grade is provided, and as a result, the abstraction-level change by the user is easily implemented by the operation of inputting the transformation rule. That is, since the user may select the plurality of transformation rules with the fine grade by the input interface, the user may easily select and change the level of the abstraction illustrated in FIGS. 8A and 8B according to the circumference.

The source code transforming method has a procedure of transforming the source code to be checked into the checking code described by the input language of the model checker by using the plurality of transformation rules, and the transformation rule is classified into the installation-generalization transformation rule, the abstraction transformation rule, and the generalization-checking transformation rule, and as a result, transformation is performed stepwise. Therefore, at the time of following up the design and the change of the source code to be checked, only a transformation rule associated with the change needs to be changed among the plurality of transformation rules, and as a result, the change may be just minimal. Moreover, the installation model, the generalization model, and the checking model are defined by the meta models, respectively and a limit is put, and as a result, it is possible to verify that a transformation result by the transformation rule is not false. Therefore, a series of processing of abstracting and transforming the source code to be checked into the checking code is implemented by combining the transformation rules with the fine grade, and as a result, an increase of a verification cost of the transformation rule may be prevented.

Further, the interface of inputting the plurality of transformation rules divided with the fine grade is provided, and as a result, the abstraction-level change by the user is easily implemented by the user's operation of selecting and inputting the transformation rule according to the desired property to be checked and the checking level. Therefore, a problem that the abstraction-level change is difficult is solved. For example, when there is a specific error which occurs only in repeated execution, the specific error is not detected by removing the repetition, but the number of states may be significantly reduced while detection of the error which does not include repetition as an occurrence cause is possible.

Further, the transformation rule of the model is accumulated in the database to be reused to cope with the design and the change of the source code to be checked or application to separate software at a low cost.

In addition, for checking with another checking tool, only the meta checking model and the generalization-checking transformation rule needs to be prepared in output in a format of the checking tool, and as a result, a preparation part may be just minimal. Therefore, a problem that a cost in checking using another model checker is high is solved.

### Second Embodiment

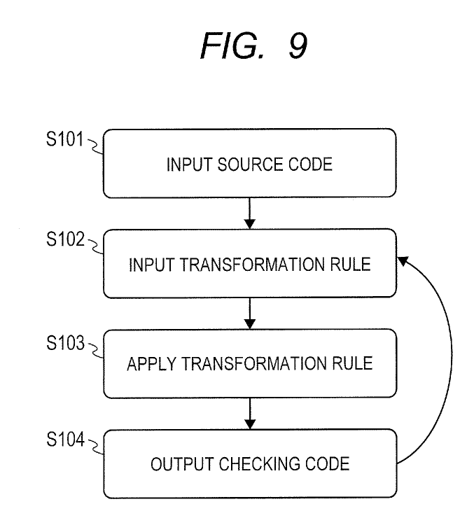

Referring to FIG. 9, a source code transformation apparatus and a source code transformation processing method that are a second embodiment of the present invention will be described. In the embodiment, as illustrated in FIG. 9, subsequently to the checking code outputting step S104, the transformation rule inputting step S102 is performed, a procedure of transforming the source code 0001 which has already been repeatedly input by using another transformation rule set 0002 may be performed. Further, in some embodiments, subsequently to the checking code outputting step S104, the transformation rule inputting step S102 is performed, and as a result, the whole or a part of the transformation rule set 0002 which has already been input and the transformation rule set 0002 newly input in the transformation rule inputting step S102 may be combined with each other to be used as the transformation rule set 0002.

According to the embodiment, the interface of inputting the plurality of transformation rules divided with the fine grade may be provided, the input source code and the transformation rule set used for transformation may be stored, and the source code may be transformed by replacing some of the transformation rule set, and as a result, an effort to repetitively transform the same source code may be reduced, such as a case where a plurality of checking codes having different abstraction degrees are generated, and the like.

### Third Embodiment

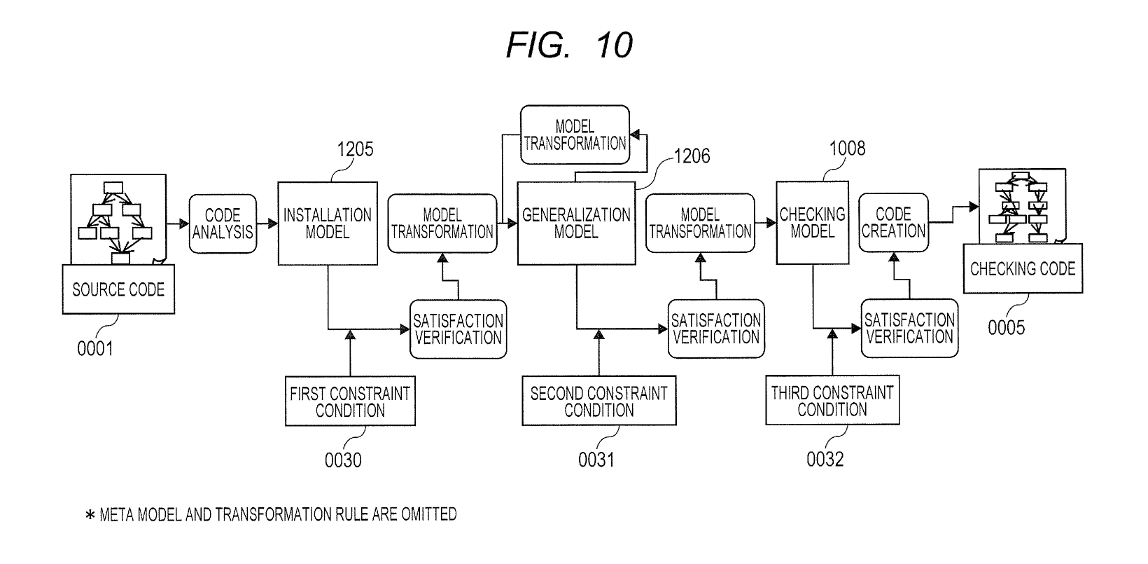

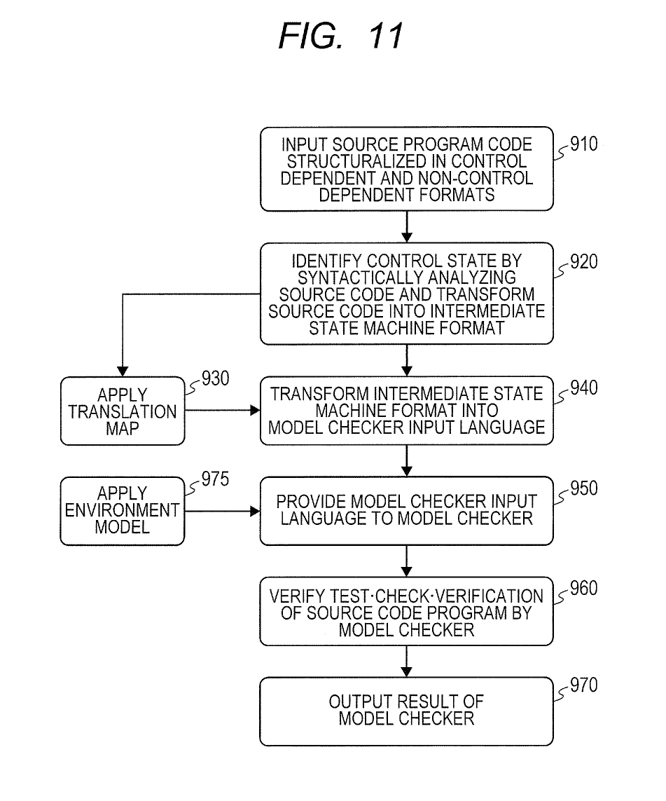

Referring to FIG. 10, a source code transformation apparatus and a source code transformation processing method that are a third embodiment of the present invention will be described. In the embodiment, a step of verifying the installation model, the generalization model, and the checking model generated during acquiring the checking code from the source code by the limit condition is provided.

By using FIG. 10, a verification procedure of transformation validity will be described in detail.

When a specific transformation rule has a precondition for a target model in transformation, the precondition of the specific transformation rule may not be satisfied when another transformation rule is applied, in a model to be transformed. Like this, when the model transformation is performed by the specific transformation rule in the case where the precondition is not satisfied, a mode of the transformation result may be in a false state. Further, even when an error is just included in the transformation rule, the model of the transformation result may be in the false state.

In the embodiment, a source code transformation processing method includes a step of inputting a source code 0001 of software, inputting a first transformation rule to transforming an installation model 1205 having information on the source code into an intermediate format (generalization model 1206) which is a format not dependent on a specific programming language, a step of inputting a second transformation rule of abstracting the intermediate format, a step of inputting a third transformation rule of transforming the intermediate format into a checking model 1008 having information on a checking code, a step of analyzing the source code 0001 of the software and transforming the analyzed source code into the installation model 1205, a step of transforming the source code 0001 of the software into the intermediate-format generalization model 1206 by using the first transformation rule, a step of abstracting software expressed in the intermediate format by using the second transformation rule, a step of transforming the intermediate format into the checking model 1008 by using the third transformation rule, a step of generating a checking code 0005 described by an input language of a verification tool by using the checking model 1008, and a satisfactory verification step of verifying the models of the respective steps by a first limit condition 0030, a second limit condition 0031, and a third limit condition 0302.

Satisfactory verification of the models of the respective steps by the first limit condition 0030, the second limit condition 0031, and the third limit condition 0032 is implemented by describing, for example, a meta model by an MOF disclosed in Non-Patent Document 2 or describing a limit condition for a model defined by a meta model by an OCL disclosed in Non-Patent Document 4.

According to the embodiment, by using the meta model and the limit condition, validity of transformation by a collision of transformation rules or an error of the transformation rule may be assured. In the model transformation, a model of a format defined by the meta model is generated. Further, by adding the limit condition, satisfactory verification of validity of the generated model may be performed according to the limit conditions 0030 to 0032.

### REFERENCE SIGNS LIST

0001 Source code
0002 Transformation rule set
0003 Meta model
0004 Writing rule
0005 Checking code
1000 Source code checking apparatus
1100 Input unit
1200 Transformation processing unit
1300 Output unit
1400 Storage unit
1001 Source code information
1002 Meta installation model
1003 Meta generalization model
1004 Meta checking model
1005 Installation-generalization transformation rule
1006 Abstraction transformation rule
1007 Generalization-checking transformation rule
1008 Checking model
1009 Checking code writing rule
1101 Source code input unit
1102 Transformation rule input unit
1201 Model construction unit
1202 Installation-generalization model transformation unit
1203 Abstraction model transformation unit
1204 Generalization-checking model transformation unit
1205 Installation model
1206 Generalization model
1301 Checking code writing unit
1401 Transformation rule database
1402 Meta model database
1403 Writing rule database
1500 Control unit
S101 Source code inputting step
S102 Transformation rule inputting step
S103 Transformation rule applying step
S104 Checking code outputting step

1. A source code transformation method by a source code transformation apparatus, comprising:
a step of inputting a source code of software;
a step of inputting a plurality of different transformation rules; and
a step of transforming the source code into a checking code described by an input language of a verification tool by the plurality of different transformation rules.

2. The source code transformation method according to claim 1,
wherein in the plurality of different transformation rules, a series of processing of transforming the source code to be checked into the checking code and abstracting the checking code are divided with a fine grade.

3. The source code transformation method according to claim 1,
wherein the transformation rules include:
a first plurality of transformation rules of transforming a source code into an intermediate format which is a format not dependent on a specific programming language,
a second plurality of transformation rules of abstracting the intermediate format, and
a third plurality of transformation rules of transforming the intermediate format into the checking code, and
the source code transformation method includes:
a step of inputting a source code of software;
a step of inputting the at least one of the first transformation rules,
a step of inputting the at least one of the second transformation rules,
a step of inputting the at least one of the third transformation rules,
a step of transforming the source code of the software into the intermediate format by using the first transformation rule,
a step of abstracting the software expressed in the intermediate format by using the second transformation rule, and
a step of transforming the intermediate format into a verification code described by an input language of a verification tool by using the third transformation rule.

4. The source code transformation method according to claim 3, further comprising:
a step of verifying the intermediate format by a limit condition.

5. The source code transformation method according to claim 1,
wherein the transformation rule includes syntax transformation of transforming conditional branching of a C language into conditional branching of the checking code.

6. The source code transformation method according to claim 1,
wherein the transformation rule includes syntax transformation of transforming a repetition statement of the C language into repetition of the checking code.

7. The source code transformation method according to claim 1, wherein at least some of the plurality of different transformation rules are selected and input from among a plurality of transformation rules accumulated in the source code transformation apparatus.

8. The source code transformation method according to claim 1,
wherein at least some of the plurality of different transformation rules are input by a user's description.

9. A source code transformation method by a source code transformation apparatus, comprising:
a step of inputting a source code of software;
a step of inputting a plurality of different transformation rules; and
a step of transforming the source code into a checking code described by an input language of a verification tool by the plurality of different transformation rules,
wherein at least some of the plurality of transformation rules are selected and input from among a plurality of transformation rules accumulated in the source code transformation apparatus.

10. The source code transformation method according to claim 9,
wherein the plurality of different transformation rules include an installation-generalization transformation rule of transforming the source code into a generalization model having generalized program information not dependent on a descriptive language of the source code, an abstraction transformation rule of abstracting the generalized model, and a generalization-checking transformation rule of transforming the generalized model into the descriptive language of the verification tool.

11. The source code transformation method according to claim 10,
wherein a format of a model which is internally kept information is defined by a meta model in a series of processing of transforming the source code to be checked into the checking code,
the model includes an installation model having information corresponding to the source code to be checked, the generalized model, and a checking model having information corresponding to the descriptive language of the verification tool,
the installation model is defined by a meta installation model which is a meta model thereof,
the generalization model is defined by a meta generalization model which is a meta model thereof,
the checking model is defined by a meta checking model which is a meta model thereof, and
the respective meta models store a definition of a data structure and information on a limit between components included in data.

12. The source code transformation method according to claim 10,
wherein the information on the transformation rule includes only identification information indicating a transformation rule stored in a storage unit of the source code transformation apparatus, and
an entity of the transformation rule is taken out from the storage unit by using the identification information to be used for transformation.

13. The source code transformation method according to claim 10,
wherein a retrieval condition of the transformation rule is extracted and generated from the input source code, and
a transformation rule which coincides with the retrieval condition is acquired from the storage unit of the source code transformation apparatus to be received as the transformation rule.

14. The source code transformation method according to claim 10,
wherein in respective intermediate models of the installation model, the abstraction program model, and the checking model, a data structure and a syntactic theory are defined by meta models that define syntaxes, respectively.

15. A source code transformation program which operates on at least one computer and configures a source code transformation apparatus, for making the computer to function as:
a unit that inputs a source code of software;
a unit that inputs a plurality of different transformation rules; and
a unit that transforms the source code into a checking code described by an input language of a verification tool by the plurality of different transformation rules.
